(19) United States
(12) Patent Application Publication
(10) Pub. No.: US 2007/0153826 A1
(43) Pub. Date: Jul. 5, 2007

(54) Method and apparatus for international media content delivery

(76) Inventor: Gady Studnitz, Woodland Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/325,771

(22) Filed: Dec. 30, 2005

(51) Int. Cl. H04L 12/28; H04J 3/22; H04J 3/16; H04L 12/56

(52) U.S. Cl. 370/466; 370/389; 370/401

(57) ABSTRACT

A system captures media programs at a source location, converts them into a different format, and transmits them to an intermediate location. The programs are re-transmitted to a destination location, where they are converted into another format and output.

### FIELD

The invention relates to multimedia content delivery. More specifically, the invention relates to international delivery of multimedia content via a distributed computer network.

### BACKGROUND

The advent of high-speed, large capacity material transport facilities has rendered the movement of people and goods across international boundaries commonplace, and the development of distributed data networks such as the Internet has done the same for many sorts of intangible information. However, some information streams are only available in geographically limited areas. For example, over-the-air television and radio broadcasts usually cannot be received over distances greater than a few hundred kilometers. Other media streams may be delivered over wired systems such as cable, but may be equally unavailable in locations where that cable service is unavailable.

Nevertheless, these broadcasts and media streams may be of interest to audiences around the world. A system to make the programs available may be of value in this field.

### SUMMARY

A media program is captured at a source and converted into a new form for transmission to an intermediate location. The program is transmitted again, from the intermediate location to a destination, where it is converted once more and prepared for display. Other embodiments are also described.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a broad overview of an embodiment of the invention.

FIG. 2 is a flow chart of operations according to an embodiment.

FIG. 3 is a block diagram of some components of a destination system.

FIG. 4 shows several destination systems cooperating to reduce load on an intermediate server.

FIG. 5 is a flow chart describing peer-to-peer operations.

### DETAILED DESCRIPTION

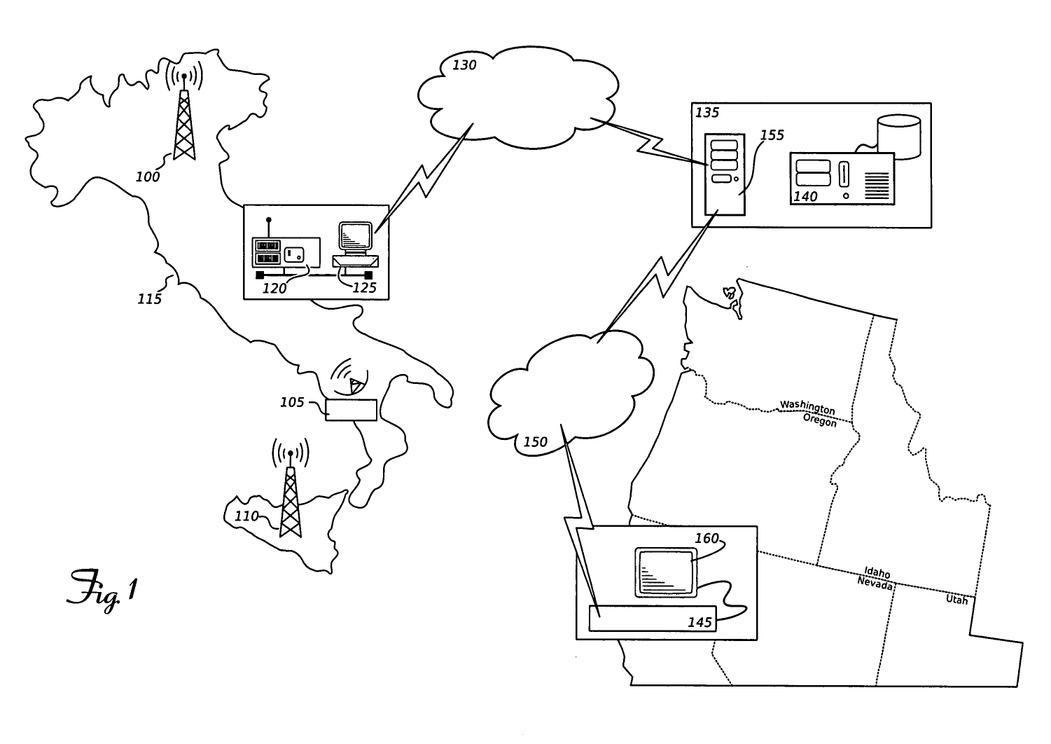

FIG. 1 shows a number of components that may interoperate to accomplish the method of an embodiment of the invention. Media sources 100, 105, 110 are broadcast television, radio, and cable television sources located in a first jurisdiction 115 (i.e. a country). A receiver 120 captures the media programs available from the sources and a converter 125 converts them from their source form to an intermediate form.

Programs may be broadcast or transmitted according to a common standard appropriate for the country in which they are intended to be received. For example, television broadcasts in much of Europe use the Phase Alteration Line (“PAL”) system (although French broadcasts may use Séquentiel Couleur Avec Mémoire, “SECAM,” instead). Other countries, including the United States, use the National Television System Committee (“NTSC”) system. Radio broadcasts may be received as frequency-modulated (“FM”) or amplitude-modulated (“AM”) signals.

These program formats are adequate for transmission over analog radio or cable systems, but they may not be well suited for transmission over a digital data network. The converter may convert the programs from a broadcast format into a binary format as described by the Moving Picture Experts Group (“MPEG”), an international standards body. MPEG has defined several formats for audio and video data, including MPEG-1, MPEG-2, MPEG-3 and MPEG-4. These formats differ in their quality, compressibility, and error recovery capacity, but any one may be suitable for the purposes of embodiments of this invention. Other binary formats may also be used.

Once a program is converted, it is transmitted over a distributed data network 130 to an intermediate location 135. There, it may be stored on storage server 140, or immediately forwarded to a following stage. The converted (and possibly delayed) program is retrieved by a system 145 at a destination location. The destination system also communicates with the intermediate location over a distributed data network 150, which may be the same network as 130. A server 155 at intermediate location 135 transmits the program to the destination system 145, and the destination system converts it from the intermediate form to a final form suitable for display or reproduction on equipment at the destination. For example, if the program is a television program, destination system 145 will receive it in a binary format such as MPEG-1, MPEG-2 or MPEG-4 and convert it to a broadcast video format such as NTSC, PAL or SECAM. The converted signal is output to a video monitor 160.

Note that destination system 145 may be located in a different jurisdiction or country than the media source. Intermediate location 135 may be in the source or destination country, or in yet a third country. Since the program data is transmitted from the receiver 120 and converter 125 to the destination system in a binary format, it can travel over a distributed data network such as the Internet without regard for distance limitations that might prevent the original broadcast signal from traveling to the destination.

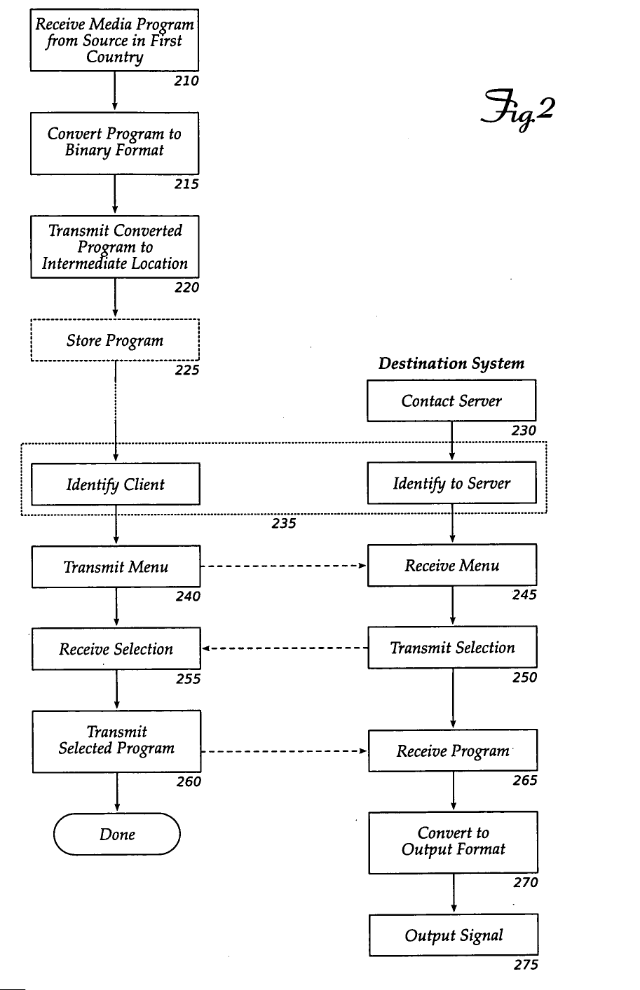

FIG. 2 shows a series of operations that may occur while an embodiment of the invention is active. A receiver receives a media program from a broadcast or cable source in a first country (210). The program is converted from its original form (e.g. PAL, SECAM, NTSC, FM audio) to a binary form suitable for transmission over a distributed data network (215). The converted program is transmitted to an intermediate location (220), and may be stored there for a period of time (225).

Later, a destination system in a different country than the broadcast or cable source contacts a server at the intermediate location (230). In some embodiments, the destination system will identify itself by transmitting a password or other authentication information, while in other embodiments, the server at the intermediate location may identify the destination implicitly, for example, by checking a network or protocol address of the destination system (235).

The server at the intermediate location may transmit a menu of available programs (240) which is received by the destination system (245); and the destination may transmit a selection (250) to be received by the intermediate server (255). After a program is selected the intermediate location server begins transmitting the program (260). In some embodiments, the server at the intermediate system may simply begin transmitting a predetermined program instead of presenting a menu and accepting a selection.

The destination system receives the transmitted program (265), (which is still in the binary transmission format), converts it to another format (270), and produces a signal in accordance with that format to drive equipment at the destination location (275). For example, if the media program is a television program, the destination system may produce an NTSC composite video signal. If the media program is a radio program, the destination system may produce a monaural or stereo audio signal. Equipment at the destination location (e.g. a television monitor or audio amplifier and speakers) reproduces the media program.

The media program source and destination system may be in different countries, separated by a great distance, and consequently there may be a significant difference between the local times in each place. A broadcast received in Italy at 8:00 p.m. local time could be converted and forwarded to a destination system in the United States within only a few seconds, but the local time at the destination system might be 11:00 a.m. It might be inconvenient for a user in the United States to view the media program at that time, so one embodiment of the invention may store the media program at the intermediate location and transmit it to a destination system later, so that a viewer at the destination system could view the program at 8:00 p.m. according to his local clock. Such an embodiment could transmit the same stored program at staggered times to destination systems in successive time zones, so that a viewer in any time zone could obtain the program at the same local time.

Some embodiments may provide receiving and converting stations in a number of source countries, with each station transmitting binary-converted data to an intermediate location.

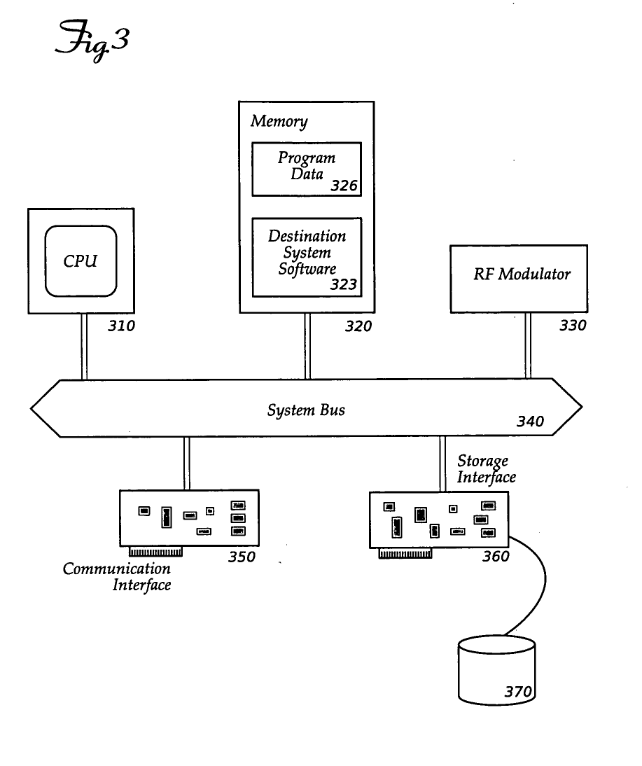

FIG. 3 shows some of the components that may be found in a destination system that can interoperate with an embodiment of the invention. Element 310 is a central processing unit (“CPU,” also called a “processor”) to execute instructions and process data in memory 320. Memory 320 may contain software 323 to control the operation of the destination system, as well as multimedia program data 326 received from an intermediate server. Radio frequency (“RF”) modulator 330 permits the destination system to produce signals to drive display devices such as video or television monitors. Communications interface 350 may be used to transmit requests to, and receive data from, a server at the intermediate location. In some embodiments, two destination systems may also communicate with each other over in a peer-to-peer fashion over a distributed data network. Some destination systems may include a storage interface 360 to read and write data on a mass storage device such as hard disk 370. In embodiments with storage systems, programs may be received and recorded for later (or repeated) playback. These system components, and others that may be found in some embodiments, can exchange data with each other across system bus 340.

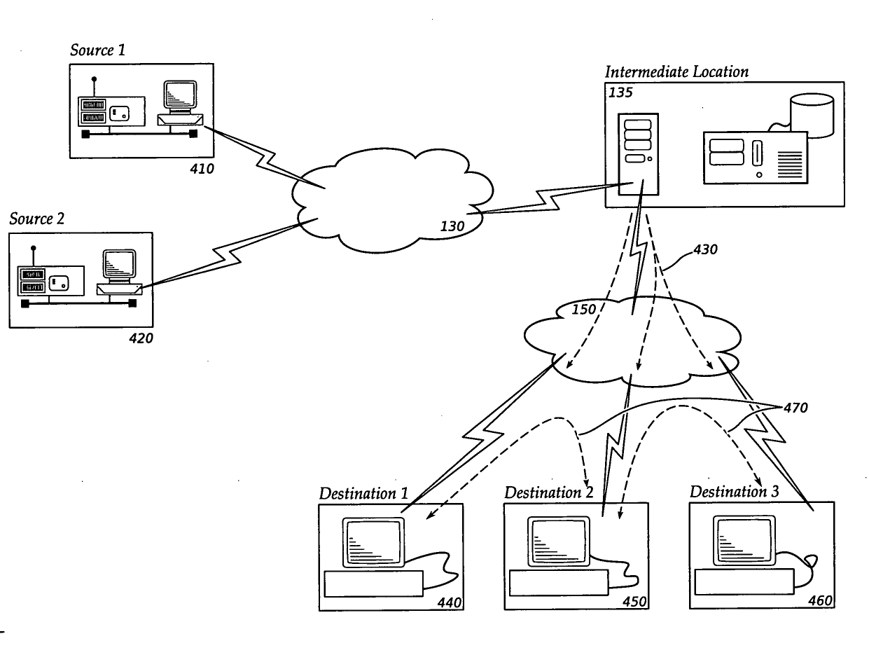

It is appreciated that a media program, when converted, may require a significant amount of storage space and/or transmission bandwidth, even if it is compressed aggressively. Therefore, some embodiments of the invention may be configured as shown in FIG. 4. Two source-location receiving and converting stations (410 and 420) obtain source media programs and convert them to a binary format. The programs are transmitted over distributed data network 130 to intermediate location 135, where they may be stored. A server in intermediate location 135 may transmit media program data to destination systems 440, 450 and 460 as shown by dashed arrows 430. However, destination systems may also transmit program data between themselves, as shown by dashed arrows 470. If a destination system can receive some of the program data from a peer destination system instead of from a server at the intermediate location, the load on the intermediate server may be reduced.

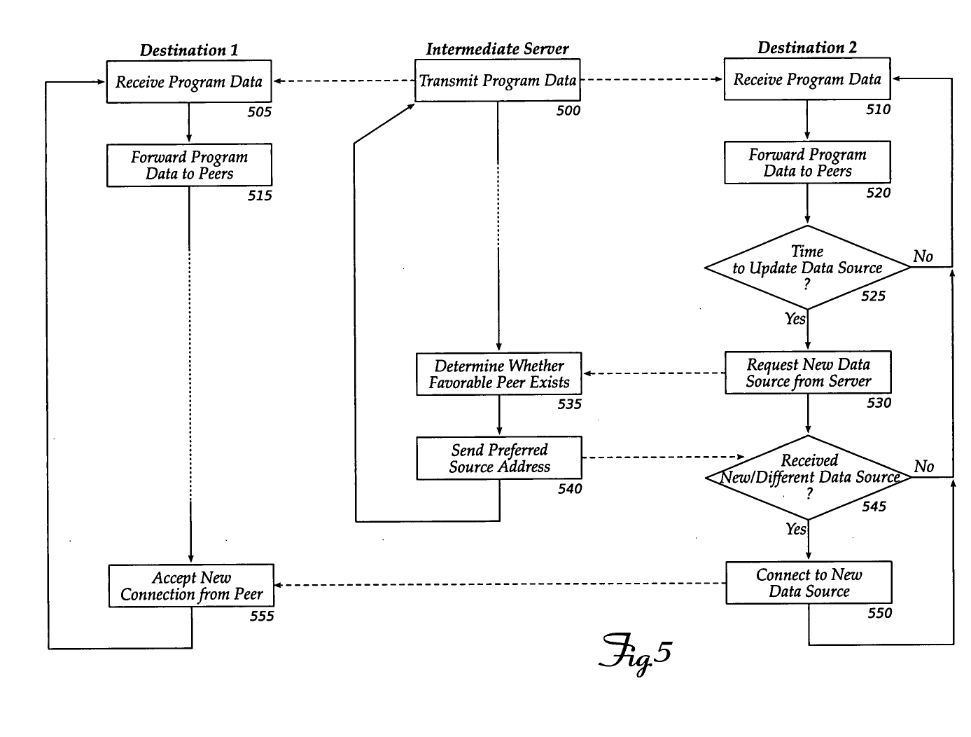

Peer-to-peer data transfer may be accomplished over the same distributed data network 150 that carries traffic from the intermediate location 135 to the various destinations 440, 450 and 460, over a public distributed data network such as the Internet, or over a virtual or true private data network that only carries data between the intermediate location and the destination systems. One possible protocol to perform peer-to-peer data distribution is described with reference to FIG. 5.

When a destination system connects to a server at the intermediate location, it receives a network address (for example, an Internet Protocol, “IP,” address) of a system from which it can obtain data for the media program. This may be the address of the intermediate server itself, or an address of another destination system. Periodically, each destination system may contact the intermediate system to determine whether there is a more favorable data source for it to use.

FIG. 5 shows some interactions between an intermediate server and two destination systems. At first, the intermediate server is transmitting program data to both destinations (500), so both destinations receive the data from the intermediate server (505, 510). After receiving such data, each destination may forward it to any connected peers (515, 520).

Destination 2 is shown checking whether it is time to update its data source (525). This check may be performed at predetermined intervals (for example, every two or three minutes). If it is time, the destination requests a new data source from the intermediate server (530), and the intermediate server reviews its records of connected destinations to determine whether a favorable peer exists (535). A peer may be favorable if it is receiving the same data stream and is within a short network distance from the querying destination. Other factors (e.g. connection speed and latency) may bear on the favorability of a peer node in an embodiment. The intermediate server sends the preferred data source address (540) and continues to distribute program data to its connected destination systems.

Destination 2 checks to see whether it has received a new or different data source (545), and if it has, it connects to the new source (550). Subsequently (until its next data source check), destination 2 will receive program data forwarded from destination 1. This will relieve some of the load on the intermediate server.

Destination 1, meanwhile, occasionally checks for new connections from peers, and (in the example described here) accepts a new connection from destination 2 (555). While destination 1 is connected to destination 2, program data destination 1 receives from the intermediate server (505) will be forwarded to destination 2 (515), and destination 2 will receive the program data from destination 1 (510).

In some embodiments, an intermediate server may direct destinations to connect in a more complicated fashion, with some destinations redistributing program data to two or more subsidiary destination levels. More complex network arrangements may be more effective at reducing load on the intermediate server, but may also result in greater delay or sporadic program interruptions. Embodiments may be tuned for a favorable balance between server load, bandwidth usage, and program distribution quality.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that media content can be delivered over long (international) distances by software and hardware that distribute the functions of embodiments of this invention differently than herein described. Such variations and implementations are understood to be captured according to the following claims.

I claim:

1. A method comprising:
capturing a media program in a source location;
converting the media program from a first format to a second format;
transmitting the media program in the second format to an intermediate location;
transmitting the media program in the second format from the intermediate location to a destination location;
converting the media program from the second format to a third format; and
outputting the media program in the third format.

2. The method of claim 1, further comprising:
storing the media program at the intermediate location for a predetermined period of time before transmitting the media program to the destination location.

3. The method of claim 2 wherein the predetermined period of time is proportional to a difference between a time zone of the source location and a time zone of the destination location.

4. The method of claim 1, further comprising:
providing a menu of available media programs to the destination location; and
receiving a request from the destination location,
wherein the media program is included in the menu of available media programs.

5. The method of claim 1 wherein capturing comprises:
receiving the media program through a broadcast channel.

6. The method of claim 1 wherein the first format is one of Phase Alteration Line (“PAL”), National Television System Committee (“NTSC”) or Séquentiel Couleur Avec Mémoire (“SECAM”).

7. The method of claim 1 wherein the second format is one of Moving Picture Experts Group (“MPEG”) version 1 (“MPEG-1”), MPEG version 2 (“MPEG-2”) or MPEG version 4 (“MPEG-4”).

8. The method of claim 1 wherein the source location is in a first international jurisdiction and the destination location is in a United States jurisdiction.

9. The method of claim 1 wherein the first transmitting operation comprises:
establishing a Transmission Control Protocol (“TCP”) connection between a source computer and a destination computer over an Internet Protocol (“IP”) distributed network; and
sending the media program in the second format from the source computer to the destination computer.

10. A system comprising:
receiving means to receive a media program;
first converting means to convert the media program from a first format to a second format;
first network communication means to transmit the media program from a source location to an intermediate location;
second network communication means to transmit the media program from the intermediate location to a destination location;
second converting means to convert the media program from the second format to a third format; and
signal generating means to produce a video signal corresponding to the media program in the third format.

11. The system of claim 10, further comprising:
time delay means to separate a time of transmitting the media program from the source location to the intermediate location from a time of transmitting the media program from the intermediate location to the destination location.

12. The system of claim 10 wherein
the first format is one of Phase Alteration Line (“PAL”), National Television System Committee (“NTSC”) or Séquentiel Couleur Avec Mémoire (“SECAM”);
the second format is one of Moving Picture Experts Group (“MPEG”) version 1 (“MPEG1”), MPEG version 2 (“MPEG2”) or MPEG version 4 (“MPEG4”); and
the third format is NTSC.

13. The system of claim 10 wherein the source location is in a non-United States jurisdiction and the destination location is in a United States jurisdiction.

14. An apparatus comprising:
a processor;
a communication interface to receive data from a distributed computer network;
a radio-frequency modulator to produce a video signal; and
a memory to contain instructions that, when executed by the processor, cause the processor to perform operations including:
establishing a data connection over the distributed computer network;
retrieving data in a first format from a server;
converting the data to a second format; and
applying the radio-frequency modulator to produce a video signal corresponding to the data.

15. The apparatus of claim 14 wherein the data comprises a television program captured from a broadcast source by a receiver located in a non-United States jurisdiction.

16. The apparatus of claim 14 wherein the memory contains additional instructions to cause the processor to perform operations comprising:
identifying the apparatus to an entity on another endpoint of the data connection;
obtaining a list of available programs;
displaying the list; and
accepting a selection of one of the available programs to be retrieved.

17. The apparatus of claim 14 wherein the memory contains additional instructions to cause the processor to perform operations comprising:
establishing a data connection with a second apparatus; and
transferring data received from the server to the second apparatus.

18. The apparatus of claim 14 wherein
the first format is one of Moving Picture Experts Group (“MPEG”) version 1 (“MPEG1”), MPEG version 2 (“MPEG2”) or MPEG version 4 (“MPEG4”); and
the second format is one of Phase Alteration Line (“PAL”), National Television System Committee (“NTSC”) or Séquentiel Couleur Avec Mémoire (“SECAM”).
